(19) United States
(12) Patent Application Publication
(10) Pub. No.: US 2024/0273629 A1
(43) Pub. Date: Aug. 15, 2024

(54) PROVIDING CONSUMER EQUITY

(71) Applicant: Philip VERGES, Dallas, TX (US)

(72) Inventor: Philip VERGES, Dallas, TX (US)

(21) Appl. No.: 18/116,199

(22) Filed: Mar. 1, 2023

Related U.S. Application Data
(60) Provisional application No. 63/444,831, filed on Feb. 10, 2023.

(51) Int. Cl. G06Q 40/06; G06Q 50/16

(52) U.S. Cl. CPC G06Q 40/06; G06Q 50/16; G06Q 2220/00

(57) ABSTRACT

A method for providing consumer equity is directed to allocating a consumer equity award to a user, establishing a consumer equity reserve, converting the reserve to an equity value, and providing the equity value to the user. An apparatus comprising a memory storing instructions executed by a processor that cause the apparatus to allocate a consumer equity award to a user, establish a consumer equity reserve, converting the reserve to an equity value, and provide the equity value to the user. A system for providing consumer equity includes a first and a second apparatus configured to exchange data to allocate a consumer equity award to a user, establish a consumer equity reserve, converting the reserve to an equity value, and provide the equity value to the user.

### CROSS-REFERENCE TO RELATED APPLICATIONS

This application claims the benefit of provisional U.S. Application No. 63/444,831 entitled “Providing Consumer Equity” filed Feb. 10, 2023, the technical disclosure of which is incorporated herein by reference in its entirety.

### BACKGROUND

### Technical Field

Novel aspects of the present disclosure relate to the field of issuing equity and more particularly, to a method, apparatus, and system for providing equity to consumers in relation to a commercial transaction with a company.

### Background

The division of income between labor and owners is moot without consumers. Consumer spending accounts for 70% of the U.S. GDP. That spending increases the value of companies providing goods and services. The increased value of those companies increases the wealth of the company owners. Wealth inequality is at record levels with 10% of the U.S. population owning 70% of U.S. wealth. The top 1% hold approximately 50% of all wealth held by the top 10%. The wealth of the top 1% is growing, gaining approximately 2 percentage points during Covid. Wealth inequality is due to a concentration of corporate stock ownership within the top 1%.

Disproportionate stock ownership is the source of wealth inequality. Increasing the portion of corporate income paid to labor is not a systemic wealth inequality fix. Imposing a wealth tax on the top 1% or 10% is not a systemic wealth inequality fix. Additionally, income redistribution risks inciting inflation and is diminished by cost-of-living increases. Income redistribution does not address the source of wealth inequality-stock ownership.

Consumers' greatest monthly expense is housing. Currently, consumers that cannot afford to purchase a house either rent a property or purchase a property by engaging a mortgage. Rent payments generate income for the property owner that can service debt and maintain the property in turn contributing to the property owner's potential to benefit from the property's appreciation. The interest included in mortgage payments generates income for the bank which contributes to the appreciation of the bank's stock.

As an example, the average purchase price of a home in the U.S. in 2000 was approximately $200,000. In 2022, the average purchase price was approximately $450,000. A $400,000 30-year mortgage at 5% results in a $2,200 monthly payment. A $400,000 30-year mortgage at 5% results in a total of $373,000 in interest. Combining the down payment interest and principal, the total purchase price for a $450,000 home is $823,000.

The average per capita income in the U.S. is $53,500. The average household income in the U.S. is $67,500. Using a ⅓ of income rule of thumb for housing expenses, the average individual in the U.S. cannot afford the mortgage payment on an average-priced house, while the average household can only marginally afford the mortgage payment on an average-priced house.

The average U.S. home appreciates at approximately 3.8% per year. Over 30 years, a $450,000 house will appreciate in value to approximately $963,000. After paying a total of $823,000, a home buyer can potentially earn $140,000 over 30 years. $140,000 in earnings represents a 17% ROI over 30 years or 0.6% per year.

In contrast, investing in shares of a business can offer exponentially higher returns over time. WELLS FARGO® is one of the largest mortgage providers in the world. Over the past 30 years from 1992 to 2022, the WELLS FARGO share price has increased from $2.00 to $44.00 hitting a high of $65.00 in 2018. Over 30 years, an investment in WELLS FARGO stock could have returned over 2100%. Over 30 years, an investment in a home financed by WELLS FARGO could have returned 17%. The magnitude of the difference in ROI potential for the WELLS FARGO consumer compared to the WELLS FARGO shareholder owning WELLS FARGO corporate stock is inequitably and grossly disproportionate.

### SUMMARY OF THE INVENTION

Novel aspects of the disclosure are directed to a method, apparatus, and system for providing equity to consumers. The method involves allocating a consumer equity award to a user for a consumer transaction between the user and a company offering the consumer equity award. The consumer equity award may be based on an amount of a payment received for the consumer transaction. The consumer equity award may only be redeemable at a time in the future. The method includes establishing a cash reserve from its income as a liability backing a redemption of the consumer equity award at the time in the future, converting the cash reserve backing the redemption of the consumer equity into the consumer equity award in response to a redemption request, and providing the consumer equity award to the user.

The apparatus includes a memory for storing instructions and a processor coupled to the memory. The processor is configured to execute the instructions to cause the apparatus to: allocate a consumer equity award to a user based on an amount of a payment received for a consumer transaction between the user and a company offering the consumer equity award; establish a cash reserve from its income as a liability backing a redemption of the consumer equity award at the time in the future; convert the cash reserve backing the redemption of the consumer equity into the consumer equity award in response to a redemption request; and provide the consumer equity award to the user. The consumer equity award may only be redeemable at a time in the future.

The system includes a first apparatus and a second apparatus collectively comprising at least one memory for storing at least one set of instructions and at least one processor coupled to the at least one memory. The at least one processor is configured to execute the at least one set of instructions to: allocate a consumer equity award to a user based on an amount of a payment received for a consumer transaction between the user and a company offering the consumer equity award; establish a cash reserve from income as a liability backing a redemption of the consumer equity award at the time in the future; convert the cash reserve backing the redemption of the consumer equity into the consumer equity award in response to a redemption request; and provide the consumer equity award to the user. The consumer equity award may only be redeemable at a time in the future. The first apparatus and the second apparatus are configured to exchange data to execute the at least one set of instructions.

Other aspects, embodiments, and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives, and advantages thereof, will be best understood by reference to the following detailed description of illustrative embodiments when read in conjunction with the accompanying figures, wherein:

FIG. 1 is a flowchart of an example of a method for providing a consumer with consumer equity based on a consumer transaction according to an illustrative embodiment.

FIG. 2A is a statement of operations for an example company implementing a process for providing a consumer with consumer equity based on a consumer transaction according to an illustrative embodiment.

FIG. 2B is a balance sheet for an example company implementing a process for providing a consumer with consumer equity based on a consumer transaction according to an illustrative embodiment.

FIG. 2C is a chart showing the change in consumer equity reserve relative to paid in capital for an example company implementing a process for providing a consumer with consumer equity based on a consumer transaction according to an illustrative embodiment.

FIG. 3 is a flowchart of a process for providing a consumer with consumer equity based on a real estate transaction according to an illustrative embodiment.

FIG. 4 is a flowchart of a high-level process for providing a consumer with consumer equity according to an illustrative embodiment.

FIGS. 5A and 5B illustrate various apparatuses capable of executing instructions to carry out a process for providing a consumer with consumer equity based on a consumer transaction according to an illustrative embodiment.

FIG. 6 is a block diagram of a system configured to exchange data for providing a consumer with consumer equity based on a consumer transaction according to an illustrative embodiment.

### DETAILED DESCRIPTION

A security is a tradable financial asset. Equity securities, such as common stocks, consist of the shares of which ownership of a corporation or company is divided. Shareholders often receive a dividend in proportion to the number of shares they own. Additionally, shareholders can choose to liquidate their securities or hold on to them. While security ownership has risk, the average stock value, especially stock in the United States, has tended to rise over time.

Ownership of securities is one of the greatest methods of generating sustainable wealth accumulation because of the effects of compounding interest. If shareholders reinvest their dividends to purchase additional securities, then on the next dividend payment period, they will earn additional dividends. If shareholders continue to reinvest their dividends, all other things equal, then the total value of their securities will exponentially increase over time.

Most consumers purchase relatively few securities because they have less disposable income. This disposable income gap between most consumers and most shareholders has created a wealth disparity over time. Novel aspects of this disclosure recognize a need for a method, apparatus, and system for providing equity to consumers to allow them to participate in efficient wealth accumulation, but which also provides a financial incentive to the issuers of the corporate stock to participate in such a program.

A consumer equity solution in the housing market holds the highest potential for transforming capitalism with the introduction of a stock accumulation opportunity for the general public. Instead of paying rent to a property owner or making mortgage payments, housing could be provided in exchange for payments that garner equity in a corporation that owns the household property.

Converting monthly housing payments (consumers highest monthly expense) into a corporate stock investment opportunity gives the general public access to the corporate stock market that is the source of wealth for the 1% and 10%. Consumer spending that garners equity for the consumer redistributes corporate stock ownership, reversing the wealth gap trend, and improving the sustainability of the democratic, capitalist economy by making the benefits of capitalism more equitable. To achieve this end, issuers of the corporate stock can establish a cash reserve from its income as a liability backing a future redemption of the corporate stock, which reduces the issuer's tax liability. Thus, both the issuer of the stock and the consumer allocated with the corporate stock both realize a benefit.

In a more general version of the disclosure, a corporation provides its clients/customers with a consumer equity award in the form of a coupon, which may be similar to reward miles offered by airlines, redeemable into equity (such as corporate stock or shares) of the corporation. The consumer equity process is executed by the corporation reserving a portion of its gross or net income and booking the reserve as a liability backing the consumer's future coupon exercise redeeming the coupon for equity. When the coupon is exercised, the portion of the subject cash reserve previously backing the future exercise is exchanged for an equity sale and equity is issued to the consumer exercising the redemption of their coupon(s). The process can be implemented and managed with conventional coupons and corporate stock certificates or with blockchain-backed utility tokens and blockchain-backed digital (cryptocurrency) shares, such as those shown in U.S. Pat. No. 10,713,722 to Gordon et al, incorporated into this disclosure by reference.

In a more particular version of the disclosure, the consumer equity award can be allocated in a real estate transaction, such as the rental or purchase of real estate. The consumer has the potential to garner equity in a real estate company that owns and manages residential property in exchange for monthly housing payments provides the housing consumer, also referred to herein as “resident stakeholders,” with the opportunity to participate in the ROI potential resulting from ownership in the corporate the residential property company. Alternatively, the consumer can garner equity in the property itself.

In this more particular version of the disclosure in which the consumer equity award is based on a real estate transaction, the real estate company offering the consumer equity award can be founded as a public company with digitized stock, which is not the consumer equity award or token. The real estate company can acquire residential real estate that can then be made available to the resident stakeholders. The monthly resident stakeholder payment services typical property ownership expenses, such as debt service and maintenance. The portion of the resident stakeholder's payment that contributes to the real estate company's capitalization rate on real estate is used to derive a consumer equity award to the resident stakeholder.

Home rental and home mortgage payments are primary examples for the application of the consumer equity process because living accommodations are typically consumers' largest recurring expense and the adoption of the consumer equity process within the living expense process is likely to have a greater impact than the adoption of the consumer equity process anywhere else a consumer spends money. Nevertheless, the consumer equity process can be adopted to appropriately compensate consumers for the value of their spending on the products and services provided by virtually any company.

The consumer equity award can be credited to the resident stakeholder in tokens, which can be a type of a utility token serving as a redeemable coupon. Resident stakeholders can accumulate the tokens every month after making monthly payments which can be made in cryptocurrency or cash. Resident stakeholders can exchange the tokens for digital shares in the real estate company, redeem the tokens for future monthly payments, or sell the tokens in the open cryptocurrency market.

Other implementations of the consumer equity process can include, but are not limited to, companies that provide a recurring service. For example, telecommunication and streaming video providers could allocate profits from consumers' monthly subscription payments as a liability backing consumer equity distributed to the customers paying monthly subscriptions. Automotive loan and lease payments are another example of recurring payments where a consumer equity process could be implemented. Furthermore, home insurance, health insurance, auto insurance are also examples of recurring consumer expenses where a consumer equity process can be implemented.

Recurring payments can create a steady accumulation of consumer equity, but an implementation of the consumer equity process is appropriate for periodic purchases of goods and services such as airline tickets, hotel rooms, gasoline, washers, dryers, watches, and groceries. The consumer equity process could also be implemented by companies that provide one-time transactions by providing a consumer equity award with the single transaction. Thus, virtually any consumer purchase could be backed by a consumer equity opportunity.

The adoption of a consumer equity process offsets the hidden fees practices designed around consumer behaviors to maximize profits. When hotels add resort fees, airlines add baggage fees, and when any business charges a late fee, to name only a few hidden fee examples, the increased profits earned at the consumer's expense can now benefit the consumer by providing the consumer an opportunity to participate in the equity appreciation resulting from increased profits.

This description, with references to the figures, presents non-limiting examples of embodiments of the present disclosure. The various embodiments of the presently disclosed subject matter are described with specificity to meet statutory requirements. However, the description itself is not intended to limit the scope of this patent. Rather, it has been contemplated that the claimed subject matter might also be embodied in other ways, to include different steps or elements similar to the ones described in this document, in conjunction with other present or future technologies. The components described hereinafter as making up various elements of the invention are intended to be illustrative and not restrictive. Many suitable components that would perform the same or similar functions as the components described herein are intended to be embraced within the scope of the invention. Such other components not described herein can include, but are not limited to, for example, similar components that are developed after development of the presently disclosed subject matter.

It should also be noted that, as used in the specification and the appended claims, the singular forms “a,” “an,” and “the” include plural references unless the context clearly dictates otherwise. References to a composition containing “a” constituent are intended to include other constituents in addition to the one named. Also, in describing the preferred embodiments, terminology will be resorted to for the sake of clarity. It is intended that each term contemplates its broadest meaning as understood by those skilled in the art and includes all technical equivalents, which operate in a similar manner to accomplish a similar purpose.

Also, the use of terms herein such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order, among or between various steps herein disclosed unless and except when the order of individual steps is explicitly required.

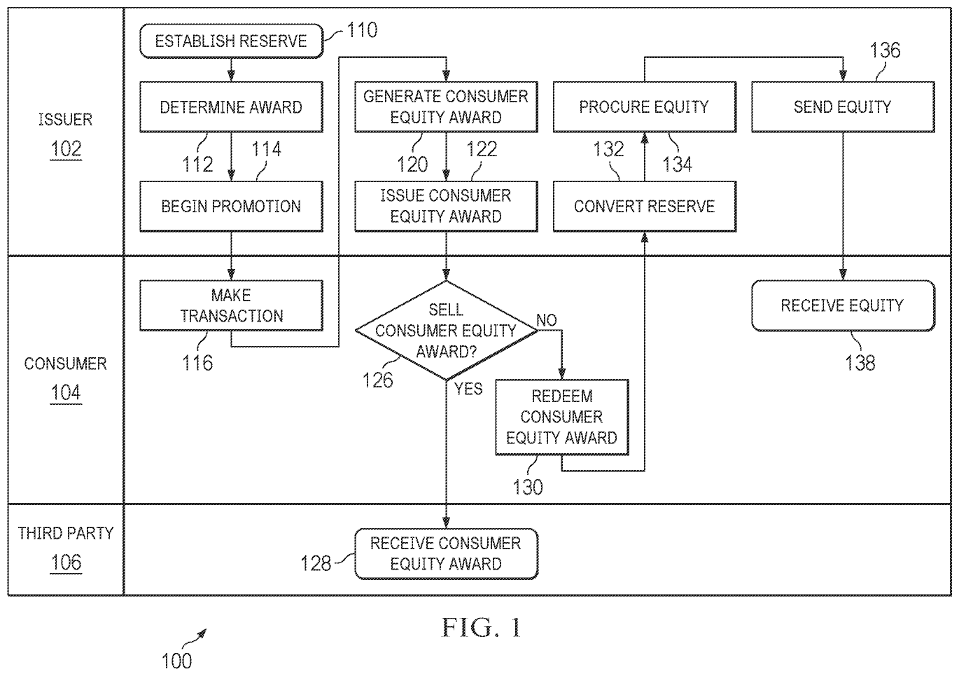

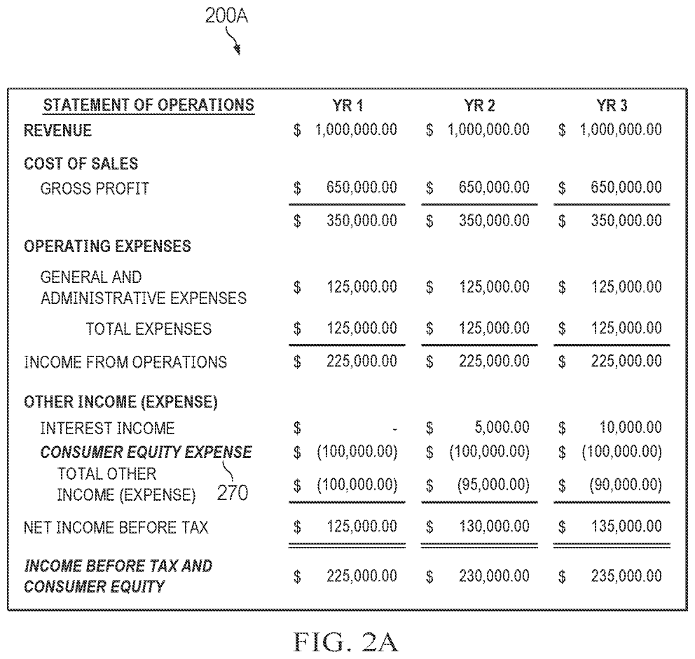

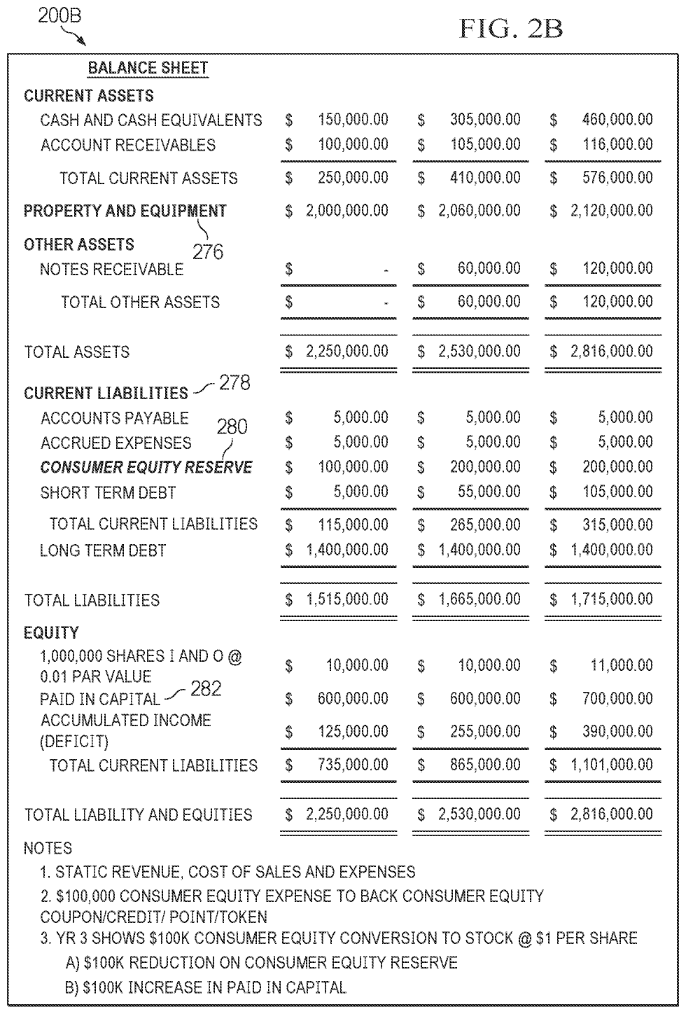

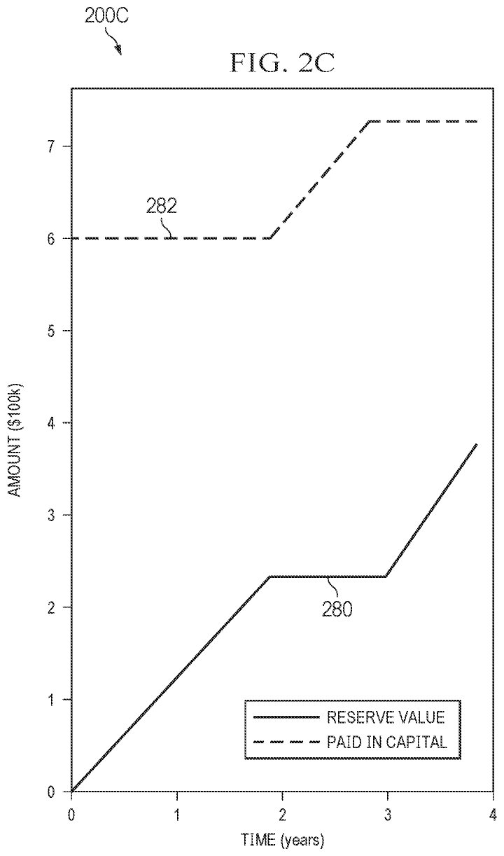

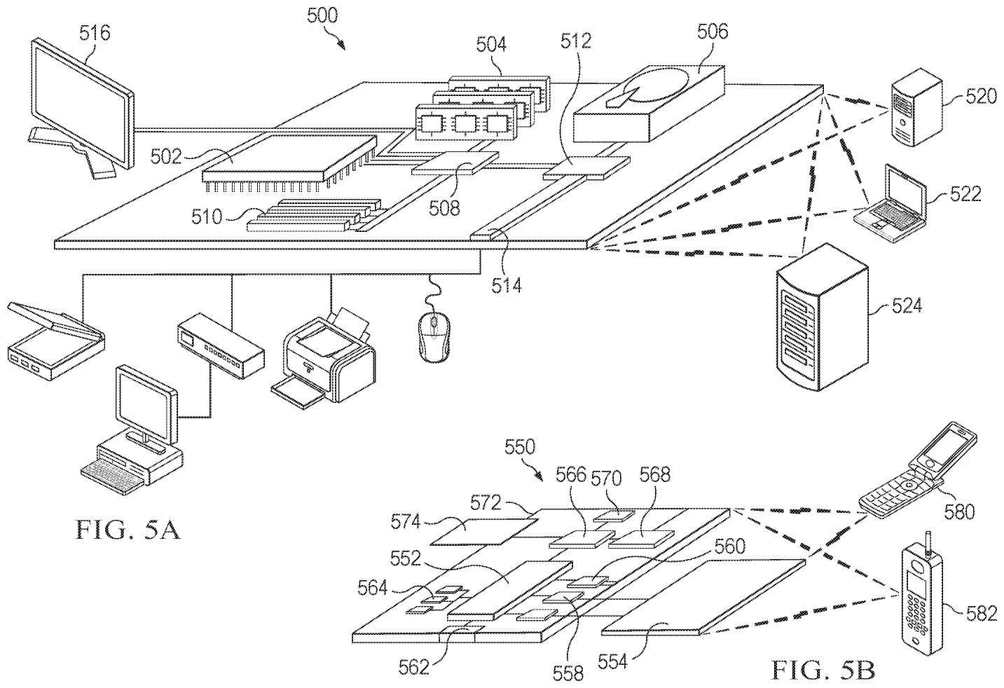

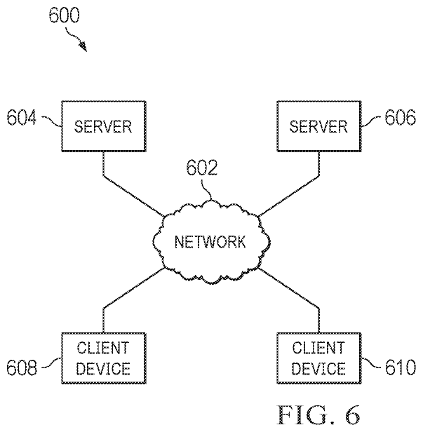

In the disclosure that follows, FIGS. 1, 3, and 4 are directed to methods for providing equity to consumers; FIGS. 2A-2C are directed to an illustrative implementation of one or more methods for providing equity to consumers; FIGS. 5A and 5B are directed to apparatuses configured to provide equity to consumers; and FIG. 6 is directed to a system for providing equity to consumers.

FIG. 1 is a drawing depicting a flowchart of a process for providing consumer equity to consumers based on a consumer transaction. The steps of flowchart 100 can be performed by an issuer 102 of a consumer equity award, a consumer 104, and optionally one or more third parties 106 in the event that the consumer equity award issued to the consumer 104 is later conveyed to the one or more third parties 106. The consumer equity award can be in the form of a redeemable coupon that can be exchanged for its equity value as described in more detail below. The equity value can be an ownership interest in the issuer 102, or a credit for a future payment instead of or in addition to an ownership interest in the issuer 102.

Flowchart 100 begins in step 110 with the issuer 102 setting aside an amount of its assets as a consumer equity reserve. The consumer equity reserve is a store of value for equity to be given to holders of a consumer equity award. In some embodiments, the issuer 102 reserves a portion of its gross or net income as the consumer equity reserve. In at least one embodiment, the consumer equity reserve is a cash reserve. On the issuer's income statement, an example of which is shown in FIG. 2A, the issuer 102 can book the consumer equity reserve as an expense that is intended to back the redeemable consumer equity award.

The issuer 102 determines a consumer equity award for a consumer transaction in step 112. Determination of the consumer equity award can include establishing the form of the consumer equity award and the value of the consumer equity award. In some embodiments, the consumer equity award can have an equity value, a monetary value, or both. In at least one example, the monetary value of a consumer equity award determines the value of equity each consumer equity award can be exchanged for. In at least another example, the equity value of each consumer equity award can determine the monetary value of the consumer equity award.

The equity value or monetary value can be based on an amount of a payment received for a consumer transaction between the consumer 104 and the issuer 102. In some versions, the equity or monetary value can be determined according to a standard agreement between the issuer 102 and the consumer 104 based on the type of consumer transaction between the parties, such as purchase contract, lease agreement, or rental agreement, or in separately executed agreements ancillary to the consumer transaction.

The equity value can be converted into an ownership interest in the issuer 102. If the issuer 102 is a business entity, it may have a number of allocated shares provided to shareholders. In some embodiments, the equity value per each consumer equity award may be a function of the current stock price on a public stock exchange. In other embodiments, the equity value may be a function of the consumer equity reserve and the number of allocated shares. In at least one version, the equity value of the consumer equity award is based on a portion of the payment received for a consumer transaction that contributes to a capitalization rate of a property. In at least one version, the issuer 102 assigns a total number of consumer equity awards based on the amount of the consumer equity reserve, the number of allocated shares, the current stock price, some other factor, or some combination thereof.

In step 114, the issuer 102 can begin an optional promotion of the equity award whereby the consumer equity award is marketed to a consumer 104 for a consumer transaction. The consumer transaction can be any kind of one-time commercial transaction, such as an outright purchase of goods, services, or real estate, a lease, a banking transaction, the issuance of credit, etc. Alternatively, the consumer transaction can be a recurring transaction, such as a payment pursuant to a rental agreement, a subscription, an installment contract, etc. In at least one example, the consumer transaction is a real estate transaction.

The consumer 104 can conduct a consumer transaction in step 116. Conducting the consumer transaction may include signing one or more agreements and making a payment to the issuer 102. The payment may be any kind of exchange of value, such as a cash transfer, bank wire, credit charge, promise to pay, sending cryptocurrency, etc. In some examples, the payment is a recurring payment, such as rental payments, a financed purchase, interest on a loan, debt service expenses, maintenance expenses, tuition, etc. In at least one example, the payment is a recurring payment based on a value of a property subject to a real estate transaction.

As part of conducting the consumer transaction, the issuer 102 may record information about the transaction, such as the date, amount of the transaction, and any restrictions for redeeming or conveying the consumer equity award. In at least one version, the consumer equity award is a redeemable coupon. In some embodiments, the consumer equity award may be a cryptographic token. The token may use distributed ledger technology, which may be a blockchain. In some examples, the token may be used to redeem digitized stocks from the issuer. In at least one example the digitized stocks are digital shares.

The issuer 102 can generate a consumer equity award in step 120. Generation of the consumer equity award can include steps necessary for creating the coupon or token, including identifying the recipient of the consumer equity award, associating a value with consumer equity award, and updating the consumer's file.

After the issuer 102 generates the consumer equity award, the issuer 102 can issue the consumer equity award to the consumer 104 in step 122. Issuing the consumer equity award can include notifying the consumer of the consumer equity award. After issuing the coupon to a consumer 104, the issuer 102 can treat the monetary value of the consumer equity award as a liability, as shown in FIG. 2A. By treating the consumer equity award as a liability, the issuer 102 can decrease its profitability, and thus its tax liability, while temporarily maintaining assets worth the monetary value of the consumer equity award until the holder of the consumer equity award redeems it. The issuer 102 receives a financial incentive to provide an additional monetary benefit to its consumer.

In some examples, after the issuer 102 issues the consumer equity award, the consumer 104 can be provided with the option to sell the consumer equity award in step 126. If the consumer 104 decides to sell the consumer equity award, then the consumer equity award can be sold to a third party 106 in step 128 according to the terms of an agreement between the issuer 102 and the consumer 104 for an amount equal to its monetary value or some other value that may be dictated by terms of the agreement. The third party 106 becomes the owner of the consumer equity award 128 and any value of and right of redemption in the consumer equity award is transferred to its new owner. The third party 106 can exchange the consumer equity award again. Additionally, the third party 106 can redeem the consumer equity award for its equity value.

In some embodiments, if the consumer equity award is a token, the consumer 104 may be able to sell the token in a cryptocurrency market. The exchange of the token may be authenticated by blockchain. With blockchain technology, the transactional history of a token is recorded. Certain implementations of blockchain technology allow the transactional history of a token to be publicly available. Because transactions can be publicly verified, blockchain transactions can be less susceptible to fraud.

If the consumer 104 decides not to sell the consumer equity award in step 126, the consumer 104 may initiate a redemption request in step 130 to redeem the consumer equity award for its equity value. There may be a minimum amount of time before the consumer equity award may be exchanged for its equity value. In at least one embodiment, the agreement between the issuer 102 and the consumer 104 may specify a wait period. The issuer 102 can reference a record of the consumer transaction to determine whether the wait period is still ongoing for a particular consumer equity award. In at least one embodiment, the wait period is 30 days.

Requiring a wait period before a consumer 104 can exchange the consumer equity award is an optional term an issuer 102 may stipulate in the agreement. While a wait period lessens the immediate benefit to the consumer 104, it provides a valuable cash flow function to the issuer 102. A wait period guarantees that the issuer 102 has some flexibility to use its assets before it must convert the consumer equity reserve into the equity value. If the issuer 102 is a business that desires more flexibility in leveraging the benefits of deferred taxable income, then a wait period may be a necessary term in an agreement to implement the disclosure.

After the wait period, the consumer equity award may enter an active period. If the issuer 102 does not require a wait period, then the active period may begin once the consumer equity award is issued to the consumer 104.

In some embodiments, the holder of the consumer equity award can exchange the consumer equity award at any time during the active period. In other embodiments, once the consumer equity award enters the active period, the holder of the consumer equity award may initiate a redemption request to begin a redemption period to exchange the consumer equity award for equity. The redemption period may be an amount of time before the issuer 102 must exchange the consumer equity award for its equity value.

In some embodiments, the issuer 102 may be able to convert the consumer equity award into its equity value near instantaneously in the form of an electronic equity transfer. In such cases, the issuer 102 would not need to include a redemption period. In other embodiments, the issuer 102 may need a substantial amount of time to exchange its assets into equity, either to process the redemption or more likely to find the assets necessary to exchange the consumer equity award into equity. Similar to the wait period, a redemption period may be necessary for issuers 102 that may require additional time to make the necessary funds available.

In some versions, if the consumer equity award is a cryptographic token implemented with blockchain technology, then the issuer 102 can review the transactional history of the token prior to redeeming the token for its equity value. Implementing a redemption period allows additional time for the issuer 102 to review the transactional history of the token and potentially investigate potentially fraudulent transactions.

After the consumer 104 or holder of the consumer equity award redeems the consumer equity award or initiates a redemption request, the issuer 102 may convert a portion of the consumer equity reserve into equity in step 132. Converting a portion of the consumer equity reserve into equity may involve converting the consumer equity reserve into equity shares paid in capital to the owner of the consumer equity award. In some versions, converting a portion of the consumer equity reserve involves increasing an operating expense of the issuer 102, increasing a liability of the issuer 102, or decreasing the revenue of the issuer 102, or some combination thereof.

If the consumer equity award is an ownership interest in a property of the issuer 102, then converting the consumer equity reserve may involve reducing an asset value of the property based on an amount of a reduction in the consumer equity reserve.

In some versions, the issuer 102 may need to optionally procure equity in step 134. For example, the issuer 102 may need to buy back shares on a public stock exchange. After the issuer 102 has procured the optional equity value of the consumer equity award, the issuer 102 can issue the equity value to the redeemer of the consumer equity award in step 136, after which the redeemer then receives the equity value in step 138.

The issuer 102, the consumer 104, and the third party 106 can perform the steps of process 100 by operating computing devices, such as apparatus 500 shown in FIG. 5A or apparatus 550 shown in FIG. 5B, which are communicating over a network, such as network 602 in FIG. 6.

FIGS. 2A-2B illustrate financial statements and FIG. 2C illustrates a chart showing the change in a consumer equity reserve and the paid in capital of an example implementation of a process for providing a consumer with consumer equity based on a consumer transaction according to an illustrative embodiment. In particular, FIG. 2A is a model statement of operations 200A of a company implementing the process for providing consumer equity and FIG. 2B is a model balance sheet 200B of a company implementing the process for providing a consumer with consumer equity based on a consumer transaction according to an illustrative embodiment.

The purpose of the model is to provide an illustration to accompany the process for providing consumer equity, such as the process 100 depicted in FIG. 1. The statement of operations (or alternatively, income statement) 200A and balance sheet 200B are based on a simple business generating $1 million in revenue with a $650 k cost of sales and $125 k in annual expenses. The model assumes no revenue growth and no increase in the cost of sales or expenses. The model balance sheet 200B includes a $2 million property/asset, 1 million shares initially issued, and $600 k in initial paid in capital 282.

The balance sheet assumes cash generated from operations will be invested to generate “other” income in addition to the company's primary product/service sales. Both the balance sheet 200B and the statement of operations 200A reflect investment and investment income in years 2 and 3. The investment income is not part of the consumer equity process. It is only added to make the model better reflect an actual business and to demonstrate some of the collateral benefits of the consumer equity process. Specifically, the consumer equity reserve 280 can be invested to generate other income.

On the statement of operations 200A, “consumer equity” 270 is captured as an expense that is intended to back an incentive for consumer transactions. The incentive is a consumer equity award redeemable (as exemplified in this model) into equity of the subject company. Consumer equity 270 may be an example of the consumer equity reserve described elsewhere in the disclosure.

In years 1 and 2, consumer equity expenses 270 are reserved on the balance sheet 200B and recorded under liabilities 278. In year 3, as illustrated in FIG. 2B, $100 k of the consumer equity reserve 280 is converted to equity at $1 per share. Accordingly, the consumer equity reserve 280 is debited by $100 k, paid in capital 282 is credited by $100 k, and the number of issued and outstanding shares are increased by 100 k. The $1 per share is assumed to be a value agreed to within an original consumer equity award agreement.

While this model demonstrates an equity example, the consumer equity award agreement could include an alternative redemption option or multiple redemption options. For instance, the consumer equity award could be redeemed into partial ownership of a $2 million property 276. Accordingly, the $2 million property asset value on the balance sheet would be reduced in conjunction with a corresponding reduction in the consumer equity reserve 280.

FIG. 2C is a chart corresponding to certain data presented in FIGS. 2A-2B. The chart 200C shows the change in the consumer equity reserve 280 and the paid in capital 282 over time. Chart 200C assumes the consumer equity reserve 280 is converted into equity at a constant rate throughout year 3.

The chart 200C shows a steady increase in the consumer equity reserve 280 in the first two years. At year 1, the consumer equity reserve 280 has a value of $100 k. At year 2, the consumer equity reserve 280 has a value of $200 k. This rising value reflects the business allocating $100 k each year towards the consumer equity reserve 280.

In year 3, the consumer equity reserve continues to allocate $100 k towards the consumer equity reserve 280. At the same time in year 3, the business converts the consumer equity reserve 280 into equity. Thus, in year 3, the business debits $100 k from the consumer equity reserve 280 and issues an additional $100 k in equity. The additional $100 k in equity is reflected in the increase in paid in capital 282 rising from $600 k at the start of year 2 to $700 k at the start of year 3. After year 3, the business stops issuing equity and continues to allocate $100 k towards the consumer equity reserve 280.

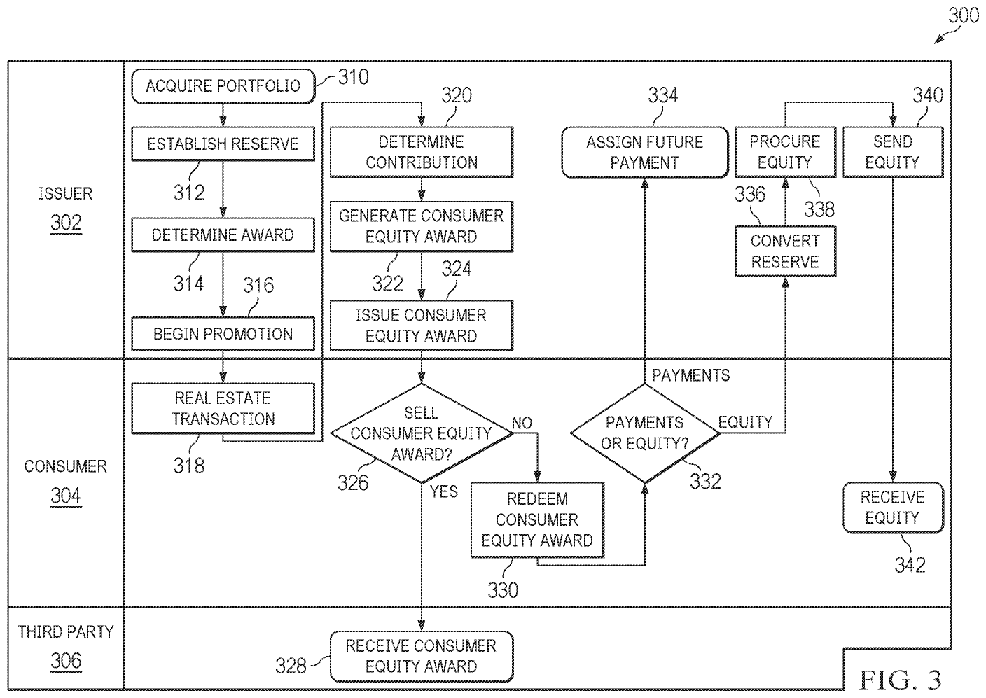

FIG. 3 is a drawing depicting a flowchart of a process for providing equity to consumers based on a real estate transaction. The steps of flowchart 300 can generally be performed by an issuer 302, a consumer 304, and one or more third parties 306 as previously described above with respect to FIG. 1. In this example, the issuer 302 is a public company offering digitized stock.

In step 310, the issuer 302 acquires a real estate portfolio. The real estate portfolio can include at least one property. The at least one property can be a residential property.

In step 312, after the issuer 302 acquires the real estate portfolio, the issuer 302 sets aside an amount of its assets as a consumer equity reserve. In some embodiments, the issuer reserves a portion of its gross or net income as the consumer equity reserve. In at least one embodiment, the consumer equity reserve is a cash reserve. On the issuer's income statement, an example of which is shown in FIG. 2A, the issuer 302 can book the consumer equity reserve as an expense that is intended to back the redeemable consumer equity award.

The issuer 302 determines a consumer equity award for a consumer transaction in step 314. The consumer equity award may take the form of a utility token that a consumer 304 can exchange for its equity value. The equity value can be an ownership interest in the issuer 302, or, in a particular embodiment, digitized shares in the issuer 302. Optionally, the consumer equity award can be an ownership interest in the at least one property. Additionally, the consumer equity award can be a credit for a future payment instead of or in addition to an ownership interest in the issuer 302.

In some embodiments, the consumer equity award may have an equity value, a monetary value, or both. In at least one example, the monetary value of a consumer equity award can determine the equity value each consumer equity award may be exchanged for. In at least another example, the equity value of each consumer equity award can determine the monetary value of the consumer equity award.

The equity value or monetary value can be based on an amount of a payment received for a real estate transaction between the consumer 304 and the issuer 302. In some versions, the equity or monetary value may be determined according to a standard agreement between the issuer 302 and the consumer 304 based on the type of real estate transaction between the parties, such as a purchase contract, lease agreement, or rental agreement, or in separately executed agreements ancillary to the real estate transaction. In at least one version, the equity or monetary value may be based on a portion of the payment contributing to a capitalization rate of the at least one property.

If the agreement is a residential stakeholder agreement, then the agreement can allow the consumer 304 to become a stakeholder in the at least one property of the issuer 302. The consumer 304 can be given an ownership interest in the property currently being rented, or another in the issuer's property portfolio, which provides benefits as already discussed above. The issuer 302 benefits by reducing its taxable liabilities and by incentivizing the establishment of long-term relationships with customers.

The equity value may also be converted into an ownership interest in the issuer 302. If the issuer 302 is a business entity, it may have a number of allocated shares provided to shareholders. In some embodiments, the equity value per each consumer equity award may be a function of the current stock price on a public stock exchange. In other embodiments, the equity value may be a function of the consumer equity reserve and the number of allocated shares. In at least one version, the equity value of the consumer equity award is based on a portion of the payment received for a consumer transaction that contributes to a capitalization rate of the property. In at least one version, the issuer 302 assigns a total number of consumer equity awards based on the amount of the consumer equity reserve, the number of allocated shares, the current stock price, some other factor, or some combination thereof.

The issuer 302 may begin an optional promotion of the equity award in step 314 whereby the consumer equity award is marketed to a consumer 304 for a real estate transaction 316.

The consumer 304 can conduct a real estate transaction in step 318. Conducting the real estate transaction may include signing one or more agreements and making a payment to the issuer 302. The payment may be any kind of exchange of value, such as a cash transfer, bank wire, credit charge, promise to pay, sending cryptocurrency, etc. In some examples, the payment is a recurring payment, such as rental payments, a financed purchase, interest on a loan, debt service expenses, maintenance expenses, etc. In at least one example, the payment is a recurring payment based on a value of a property subject to a real estate transaction.

In an example when the real estate transaction is a recurring residential stakeholder payment, the residential stakeholder payment may be specified according to the agreement between the issuer 302 and the consumer 304. As part of the residential stakeholder payment, the consumer's 304 payments may service typical property ownership expenses, such as debt service and maintenance.

As part of conducting the consumer transaction, the issuer 302 can record information about the transaction, such as the date, amount of the transaction, and any restrictions for redeeming or conveying the consumer equity award. In at least one version, the consumer equity award is a coupon. In some embodiments, the consumer equity award may be a cryptographic token. In a preferred embodiment, the cryptographic token is a utility token. The token may use distributed ledger technology, which may be a blockchain.

In some versions, the token may be used to redeem digitized stocks from the issuer 302. In at least one version the digitized stocks are digital shares. The token can be assigned to a future payment of a real estate transaction, such as a future monthly rental payment. While this disclosure emphasizes the importance of building equity overtime, the option to reduce future rental payments may be a temporary necessity for the consumer 304.

After the consumer 304 makes a real estate transaction, the issuer 302 can determine the payment's contribution to a capitalization rate of the property in step 320. After the issuer 302 determines the contribution, the issuer 302 can generate a consumer equity award in step 322 based on the results of the determination made in step 320. Generation of the consumer equity award can include steps necessary for creating the coupon or token, including identifying the recipient of the consumer equity award, associating a value with consumer equity award, and updating the consumer's file.

After the issuer 302 generates the consumer equity award, the issuer 302 can issue the consumer equity award to the consumer 304 in step 324. Issuing the consumer equity award can include notifying the consumer of the consumer equity award. After issuing the coupon to a consumer 304, the issuer 302 can treat the monetary value of the consumer equity award as a liability, as shown in FIG. 2A. By treating the consumer equity award as a liability, the issuer 302 can decrease its profitability, and thus its tax liability, while temporarily maintaining assets worth the monetary value of the consumer equity award until the holder of the consumer equity award redeems it. The issuer 302 receives a financial incentive to provide an additional monetary benefit to its consumer 304.

In some examples, after the issuer 302 issues the consumer equity award, the consumer 304 can be provided with the option to sell the consumer equity award in step 326. If the consumer 304 decides to sell the consumer equity award, then the consumer equity award can be sold to a third party 306 in step 328 according to the terms of an agreement between the issuer 302 and the consumer 304 for an amount equal to its monetary value or some other value that may be dictated by terms of the agreement. The third party 306 becomes the owner of the consumer equity award 328. And any value and right of redemption of the consumer equity award is transferred to its new owner. The third party 306 may exchange the consumer equity award again. Additionally, the third party 306 may initiate a redemption request to redeem the consumer equity award for its equity value.

In some embodiments, if the consumer equity award is a token, the consumer 304 can sell the token in a cryptocurrency market. The exchange of the token can be authenticated by blockchain. With blockchain technology, the transactional history of a token is recorded. Certain implementations of blockchain technology allow the transactional history of a token to be publicly available. Because transactions can be publicly verified, blockchain transactions can be less susceptible to fraud.

If the consumer 304 decides not to sell the consumer equity award in step 326, the consumer 304 can initiate a redemption request in step 330 to redeem the consumer equity award for its equity value. After the consumer 304 redeems the consumer equity award, the consumer 304 can decide whether to apply the equity value to a future payment or to receive the equity value. Thus, in step 332 a decision can be made as to whether the consumer equity award should be applied to a future payment. If the consumer 304 or holder of the consumer equity award decides to apply the equity value to a future payment, then in step 332, the issuer 302 can assign the equity value of the consumer equity award to a future payment in step 334, thereby reducing one or more future payments for a consumer transaction.

In step 332, if a decision is made not to apply the consumer equity award to a future payment, then flowchart 300 proceeds from step 332 to step 336 where the issuer converts at least a portion of the consumer equity reserve into equity. Converting a portion of the consumer equity reserve into equity can involve converting the reserve into equity shares paid in capital to the owner of the consumer equity award. In some versions, converting a portion of the consumer equity reserve involves increasing an operating expense of the issuer 302, increasing a liability of the issuer 302, or decreasing the revenue of the issuer 302, or some combination thereof.

If the consumer equity award is an ownership interest in a property of the issuer 302, then converting the consumer equity reserve can involve reducing an asset value of the property based on an amount of a reduction in the consumer equity reserve.

In some embodiments, a consumer may elect to receive the equity value of the consumer equity award after a minimum amount of time. In at least one embodiment, the agreement between the issuer 302 and the consumer 304 may specify a wait period. The issuer 302 can reference a record of the consumer transaction to determine whether the wait period is still ongoing for a particular consumer equity award. In at least one embodiment, the wait period is 30 days.

Requiring a wait period before a consumer 304 may exchange the consumer equity award is an optional term the issuer 302 may stipulate in the agreement. While a wait period reduces the immediate benefit to the consumer 304, it provides a valuable cash flow function to the issuer 302. A wait period guarantees that the issuer 302 has some flexibility to use its assets before it must exchange its assets into equity. If the issuer 302 is a business that desires more flexibility in leveraging the benefits of deferred taxable income, then a wait period may be a necessary term in an agreement to implement the disclosure.

After the wait period, the consumer equity award may enter an active period. If the issuer 302 does not require a wait period, then the active period can begin once the consumer equity award is issued to the consumer 304.

In some embodiments, the holder of the consumer equity award can exchange the consumer equity award at any time during the active period. In other embodiments, once the consumer equity award enters the active period, the holder of the consumer equity award can initiate a redemption request which begins a redemption period to exchange the consumer equity award for equity. The redemption period may be a minimum amount of time that the issuer 302 has to exchange the consumer equity award for its equity value.

In some embodiments, the issuer 302 can convert the consumer equity award into its equity value nearly instantaneously in the form of an electronic equity transfer. In such cases, the issuer 302 would not need to include a redemption period. In other embodiments, the issuer 302 may need a substantial amount of time to exchange its assets into equity, either to process the redemption or more likely to find the assets necessary to exchange the consumer equity award into equity. Similar to the wait period, a redemption period may be necessary for issuers 302 that may require additional time to make the necessary funds available.

In some versions, if the consumer equity award is a cryptographic token with blockchain technology, then the issuer 302 can review the transactional history of the token prior to redeeming the token for its equity value. Implementing a redemption period allows additional time for the issuer 302 to review the transactional history of the token and potentially investigate potentially fraudulent transactions.

In some versions, the issuer 302 may need to optionally procure equity in step 338. For example, the issuer 302 may need to buy back shares on a public stock exchange. After the issuer 302 has procured the optional equity value of the consumer equity award, the issuer 302 can issue the equity value to the redeemer of the consumer equity award in step 340, after which the redeemer then receives the equity value in step 342.

The issuer 302, the consumer 304, and the third party 306 can perform the steps of process 300 by operating computing devices, such as apparatus 500 shown in FIG. 5A or apparatus 550 shown in FIG. 5B, which are communicating over a network, such as network 602 in FIG. 6.

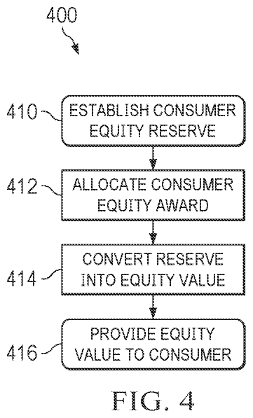

FIG. 4 is a block diagram of a flowchart of a high-level process for providing a consumer with consumer equity. The steps of flowchart 400 can be implemented in an apparatus, such as apparatus 500 or apparatus 550 in FIGS. 5A and 5B, respectively, by executing instructions stored in memory. Additionally, flowchart 400 of the process can be implemented according to the system in FIG. 6. The steps of flowchart 400 allows an issuer, such as an issuer 102 in FIG. 1 or issuer 302 in FIG. 3, to provide consumer equity to one or more consumers. The issuer can be a car manufacturer or dealership, or a homebuilder or real estate company selling or renting properties in a real estate portfolio. In addition, the issuer can be a public company offering digitized stock.

Flowchart 400 begins at step 410 by establishing a consumer equity reserve. The consumer equity reserve can be established by reserving a portion of a gross or net income of an issuer as the consumer equity reserve. The amount of the consumer equity reserve can be calculated based on a number of factors including projected sales or actual sales. In at least one embodiment, the consumer equity reserve is a cash reserve. The consumer equity reserve can be booked as an expense that is intended to back the redeemable consumer equity award on the issuer's income statement. The redemption of the consumer equity award may occur at a time in the future.

The consumer equity award may be in the form of a utility token that functions as a redeemable coupon. In at least one version, the consumer equity award may be exchanged with a third party. The consumer equity award may also take the form of a coupon that a consumer can exchange for its equity value. In some versions, the equity value is an ownership interest in the issuer. In at least one version, the consumer equity award is a credit for a future payment instead of or in addition to an ownership interest in the issuer.

In step 412, a consumer equity award is allocated to a user. The consumer equity award can be allocated to a consumer taking part in a consumer transaction by associating a portion of the consumer equity reserve to the consumer based on the amount of one or more payments received from the consumer.

The consumer transaction can be any kind of commercial transaction, such as a purchase of goods, services, or real estate, a lease, a banking transaction, the issuance of credit, etc. A part of the consumer transaction can involve recording information about the transaction, such as the date, amount of the transaction, and any restrictions for redeeming or conveying the consumer equity award.

In some examples, the consumer transaction is a recurring transaction, such as a rental agreement, a subscription, an installment contract, etc. In some versions, the consumer transaction is a recurring residential stakeholder payment. The residential stakeholder payment may be specified according to the agreement between the issuer and the user. As part of the residential stakeholder payment, the user's payments may service one or more typical property ownership expenses, such as debt service expenses and maintenance expenses.

The allocation of the consumer equity award can also include providing the actual consumer equity award to the consumer. The allocation of the consumer equity award can also include a conveyance of the consumer equity award to a third party, such as by sale or gift. Conveyance of the consumer equity award to the third party can be made pursuant to the terms of an agreement between the issuer and the consumer for an amount equal to its monetary value or some other value that may be dictated by terms of the agreement. When conveyed, the consumer equity award is reassigned to the third party, who becomes the owner of the consumer equity award. Any value and right of redemption of the consumer equity award are transferred to its new owner. The new owner may exchange the consumer equity award again or initiate a redemption request to redeem the consumer equity award for its equity value.

If the consumer equity award is a cryptographic token, the token can be sold in a cryptocurrency market. In at least one example, the consumer equity award is tied to an identifier of the consumer. The exchange of the token may be authenticated by blockchain. With blockchain technology, the transactional history of a token is recorded. Certain implementations of blockchain technology allow the transactional history of a token to be publicly available. Because transactions can be publicly verified, blockchain transactions can be less susceptible to fraud. The token can be used to redeem digitized stocks from the issuer, which can be digital shares. In one version, the token can be assigned to a future payment of a real estate transaction, such as a future monthly rental payment.

In some embodiments, the consumer equity award may have an equity value, a monetary value, or both. In at least one example, the monetary value of a consumer equity award may determine the value of equity each consumer equity award may be exchanged for. In at least another example, the equity value of each consumer equity award may determine the monetary value of the consumer equity award.

The equity value or monetary value may be based on an amount of a payment received for a consumer transaction between the consumer and the issuer. In at least one example, the consumer transaction is a real estate transaction. In some versions, the equity or monetary value may be determined according to a standard agreement between the issuer and the consumer based on the type of consumer transaction between the parties, such as a purchase contract, lease agreement, or rental agreement, or in separately executed agreements ancillary to the consumer transaction.

The equity value can be converted into an ownership interest in the issuer. If the issuer is a business entity, it may have a number of allocated shares provided to shareholders. In some embodiments, the equity value per each consumer equity award may be a function of the current stock price on a public stock exchange. In other embodiments, the equity value may be a function of the consumer equity reserve and the number of allocated shares. In at least one version, the equity value of the consumer equity award is based on a portion of the payment received for a consumer transaction that contributes to a capitalization rate of a property.

In at least one version, a total number of consumer equity awards are assigned based on the amount of the consumer equity reserve, the number of allocated shares, the current stock price, some other factor, or some combination thereof.

In step 414, the consumer equity reserve is converted into an equity value. The conversion can take place in response to a redemption request submitted by the holder of the consumer equity award. In some versions, a portion of the consumer equity reserve can be converted into equity shares paid in capital to the consumer or holder of the consumer equity award. In at least one version, converting a portion of the consumer equity reserve involves increasing an operating expense of the issuer, increasing a liability of the issuer, or decreasing the revenue of the issuer, or some combination thereof.

If the equity value of the consumer equity award is an ownership interest in the property of the issuer, then as part of the conversion an asset value of the property can be reduced based on an amount of a reduction in the consumer equity reserve.

There may be a minimum amount of time after initiating a redemption request before the consumer equity award may be exchanged for equity. In some embodiments, the agreement between the issuer and the user may specify a wait period. A record of the consumer transaction may be referenced to determine whether the wait period is still ongoing for a particular consumer equity award. In at least one embodiment, the wait period is 30 days.

Requiring a wait period before the consumer equity award is exchanged for its equity value is an optional term the issuer may stipulate in the agreement. While a wait period reduces the immediate benefit to the user, it provides a valuable cash flow function to the issuer. A wait period guarantees that the issuer has some flexibility to use its assets before it must exchange its assets into equity. If the issuer is a business that desires more flexibility in leveraging the benefits of deferred taxable income.

After the wait period, the consumer equity award can enter an active period. If the consumer equity award does not require a wait period before being exchanged for its equity value, then the active period can begin once the consumer equity award is issued.

In some embodiments, the holder of the consumer equity award can exchange the consumer equity award at any time during the active period. In other embodiments, once the consumer equity award enters the active period, the holder of the consumer equity award can initiate a redemption request which begins a redemption period to exchange the consumer equity award for equity. The redemption period may be a minimum amount of time before the consumer equity award must be exchanged for its equity value.

In some embodiments, the consumer equity award can be converted into its equity value near instantaneously in the form of an electronic equity transfer. In such cases, a redemption period is not needed. In other embodiments, a substantial amount of time may be needed to exchange its assets into equity, either to process the redemption or more likely to find the assets necessary to exchange the consumer equity award into equity. Similar to the wait period, a redemption period may be necessary for issuers that may require additional time to make the necessary funds.

In some versions, if the consumer equity award is a cryptographic token with blockchain technology, the transactional history of the token can be reviewed prior to redeeming the token for its equity value. Implementing a redemption period allows additional time to review the transactional history of the token and potentially investigate potentially fraudulent transactions.

The equity value of the consumer award is provided to the consumer in step 416. The manner in which the equity value is provided to the consumer can vary. In one example, the equity value is an ownership in the issuer and the equity value is provided by issuing shares of stock to the consumer. In another example, the equity value is a credit for a future payment and the equity value is provided by reducing an outstanding balance owed to the issuer by the credit amount.

In some embodiments, certain steps of flowchart 400 can correspond with steps of flowchart 100 in FIG. 1. For example, step 410 can correspond with step 110; step 412 of can correspond with steps 112, 114, 120, and 122; step 414 can correspond with step 132 and 134; and step 416 can correspond with step 136. Likewise, certain steps of flowchart 400 can correspond with steps of flowchart 300 in FIG. 3. Step 410 can correspond with step 312; step 412 can correspond with steps 314, 316, 320, 322, and 324; step 414 can correspond with step 336; and step 416 can correspond with step 340.

FIGS. 5A and 5B show examples of an apparatus with at least one processor capable of executing instructions to perform the steps of flowchart 400. The apparatus can also be implemented according to the system in FIG. 6. The apparatus may be a generic computer device 500 as shown in FIG. 5A and a generic mobile computer device 550 as shown in FIG. 5B, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high-speed controller 508 manages bandwidth-intensive operations for the computing device 500, while the low-speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a BLUETOOTH, WIFI, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

FIG. 6 is a block diagram of a system for providing consumer equity to consumers according to an illustrative embodiment. In particular, the system 600 includes a network 602 that allows one or more electronic devices to exchange data that allows an issuer to provide consumer equity to one or more consumers based on a consumer transaction. Although communications are depicted as proceeding through network 602, in another embodiment one or more of the electronic devices can communicate directly with other electronic devices via device-to-device communications protocols.

In a non-limiting example, server 604 is a computing device like apparatus 500 in FIG. 5A, which is under the ownership or control of an issuer. The server 604 can store at least one set of instructions that cause the server 604 to perform the steps of flowchart 400 in FIG. 4 to provide the consumer with a consumer equity in response to a consumer transaction between the consumer and issuer.

The consumer can operate client device 608, which can be a computing device such as apparatus 500 in FIG. 5A or apparatus 550 in FIG. 5B, to conduct various aspects of the consumer transaction, such as signing agreements, selecting options, making payments, redeeming one or more consumer equity awards, and receiving notifications. The consumer can also use the client device 608 to convey the consumer equity award to a third-party operating a client device, such as client device 610. Like client device 608, client device 610 can also be a computing device such as apparatus 500 in FIG. 5A or apparatus 550 in FIG. 5B.

In some versions, the issuer can provide equity to its consumers by outsourcing some or all of the computations to perform one or more methods of the disclosure to a separate entity. In these versions, the consumer can interact with a server 606 under the ownership or control of another entity. The server 606 can be a computing device such as apparatus 500 in FIG. 5A. The server 606 can store at least one set of instructions that cause the server 606 to perform the steps of flowchart 400 in FIG. 4 to provide the consumer with a consumer equity in response to a consumer transaction between the consumer and issuer. Meanwhile, the issuer can still continue to establish a consumer equity reserve by itself. The issuer and the separate entity can each perform some of the steps of one or more methods of the disclosure in any combination to accomplish the one or more methods. In at least one example, the server 604 and the server 606 are configured to exchange data to execute the at least one set of instructions.

In some examples, the consumer equity award is a cryptographic token that uses blockchain. The network 602 may be one or more websites, applications, programs, or other mediums capable of exchanging the consumer equity award. In at least one example, the network 602 is an online marketplace for exchanging digital cryptographic tokens. Further, computing devices in system 600 can authenticate an exchange of the consumer equity award from a first user operating client device 608 to a second user operating client device 610. If the consumer equity award is a cryptographic token, then the exchange can be authenticated by blockchain. Other forms of authenticating technology can be substituted instead.

Various implementations of the methods, devices, systems, and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium”, and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for providing consumer equity, the method comprising:
allocating a consumer equity award to a user based on an amount of a payment received from the user for a consumer transaction between the user and a company offering the consumer equity award, wherein the transaction comprises a purchase of a good or service of the company by the user and an amount of the consumer equity is based on the purchase amount, and wherein the consumer equity award is redeemable by the user at a time in the future;
establishing a cash reserve, from income to the company from the purchase, as a liability to the company for backing a redemption of the consumer equity award at the time in the future;
converting the cash reserve backing the redemption of the consumer equity award into an equity value in the company in response to a redemption request received from the user at the time in the future; and
providing the equity value to the user.

2. The method of claim 1, wherein:
the equity value is an ownership interest in the company offering the consumer equity award;
establishing a cash reserve comprises a wait period before the user may initiate a redemption request; and
converting the cash reserve comprises converting the cash reserve into equity shares paid in capital to the user.

3. The method of claim 1, wherein:
the equity value is credit for a future payment, and
converting the cash reserve further comprises one of (1) increasing an operating expense of the company, (2) increasing a liability of the company, or (3) decreasing revenue of the company.

4. The method of claim 1, wherein:
the consumer transaction is a real estate transaction;
the payment is a recurring payment based on a value of a property subject to the real estate transaction; and
allocating the consumer equity award further comprises determining an amount of the equity value based on a portion of the payment contributing to a capitalization rate of the property.

5. The method of claim 4, wherein:
the equity value is an ownership interest in the property, and
converting the cash reserve backing the redemption of the consumer equity award into the equity value further comprises reducing an asset value of the property based on an amount of a reduction in the consumer equity reserve.

6. The method of claim 4, wherein:
the real estate transaction is a rental or a purchase of the property;
the method further comprises:
acquiring a real estate portfolio that includes the property; and
receive a selection of the property from one or more properties in the real estate portfolio.

7. The method of claim 4, wherein the payment includes at least one of debt service expenses and maintenance expenses.

8. The method of claim 1, wherein the consumer equity award is a cryptographic token allocated in response to receiving the payment.

9. The method of claim 8, wherein the token can be assigned to another user.

10. The method of claim 9, wherein:
establishing a cash reserve comprises a redemption period before the company must exchange the token for its equity value;
converting the cash reserve further comprises reviewing the transactional history of the token during the redemption period; and
the ownership of the token is authenticated by blockchain.

11. An apparatus for providing consumer equity, the apparatus comprising:
a memory storing instructions; and
a processor coupled with the memory, the processor configured to execute the instructions to cause the apparatus to:
allocate a consumer equity award to a user based on an amount of a payment received from the user for a consumer transaction between the user and a company offering the consumer equity award, wherein the transaction comprises a purchase of a good or service of the company by the user and an amount of the consumer equity is based on the purchase amount, and wherein the consumer equity award is redeemable by the user at a time in the future;
establish a cash reserve, from income to the company from the purchase, as a liability to the company for backing a redemption of the consumer equity award at the time in the future;
convert the cash reserve backing the redemption of the consumer equity award into an equity value in the company in response to a redemption request received from the user at the time in the future; and
provide the equity value to the user.

12. The apparatus of claim 11, wherein:
the equity value is an ownership interest in the company offering the consumer equity award; and
instructions for converting the cash reserve backing the redemption of the consumer equity award into the equity value further comprises instructions that, when executed by the processor, causes the apparatus to convert the cash reserve into equity shares paid in capital to the user.

13. The apparatus of claim 11, wherein:
the equity value is credit for a future payment, and
instructions for converting the cash reserve backing the redemption of the consumer equity award into the equity value further comprises instructions that, when executed by the processor, causes the apparatus to: (1) increase an operating expense of the company, (2) increase a liability of the company, or (3) decrease revenue of the company.

14. The apparatus of claim 11, wherein:
the consumer transaction is a real estate transaction;
the payment is a recurring payment based on a value of a property subject to the real estate transaction; and
instructions for allocating the consumer equity award further comprises instructions that, when executed by the processor, causes the apparatus to determine an amount of the equity value based on a portion of the payment contributing to a capitalization rate of the property.

15. The apparatus of claim 14, wherein:
the equity value is an ownership interest in the property, and
instructions for converting the cash reserve backing the redemption of the consumer equity award into the equity value further comprises instructions that, when executed by the processor, causes the apparatus to reduce an asset value of the property based on an amount of a reduction in the consumer equity reserve.

16. The apparatus of claim 14, wherein:
the real estate transaction is a rental or a purchase of the property;
the payment includes at least one of debt service expenses and maintenance expenses; and
the instructions include additional instructions that, when executed by the processor, causes the apparatus to receive a selection of the property from one or more properties in a real estate portfolio.

17. The apparatus of claim 11, wherein the consumer equity award is a token allocated in response receiving the payment.

18. The apparatus of claim 17, wherein the instructions include further instructions that, when executed by the processor, causes the apparatus to reassign the token to another user.

19. The apparatus of claim 18, wherein ownership of the token is authenticated by blockchain.

20. A system for providing consumer equity, the system comprising:
a first apparatus and a second apparatus collectively comprising:
at least one memory storing at least one set of instructions; and
at least one processor coupled with the at least one memory, the at least one processor configured to execute the at least one set of instructions to:
allocate a consumer equity award to a user based on an amount of a payment received from the user for a consumer transaction between the user and a company offering the consumer equity award, wherein the transaction comprises a purchase of a good or service of the company by the user and an amount of the consumer equity is based on the purchase amount, and wherein the consumer equity award is redeemable by the user at a time in the future;
establish a cash reserve, from income to the company from the purchase, as a liability to the company backing a redemption of the consumer equity award at the time in the future;
convert the cash reserve backing the redemption of the consumer equity award into an equity value in the company in response to a redemption request received from the user at the time in the future; and
provide the equity value to the user;
wherein the first apparatus and the second apparatus are configured to exchange data to execute the at least one set of instructions.
